(19) United States
(12) Patent Application Publication
(10) Pub. No.: US 2026/0082150 A1
(43) Pub. Date: Mar. 19, 2026

(54) MICROPHONE ARRAY AND PORTABLE DEVICE

(71) Applicant: AAC Technologies Pte. Ltd., Singapore (SG)

(72) Inventors: Stefan Albert Wirler, Helsinki (FI); Juha Backman, Tampere (FI); Timo Lamberg, Tampere (FI); Antti Kangasaho, Tampere (FI)

(21) Appl. No.: 18/888,193

(22) Filed: Sep. 18, 2024

(51) Int. Cl. H04R 3/00

(52) U.S. Cl. CPC H04R 3/005; H04R 2499/15

(57) ABSTRACT

A microphone array and a portable device. The microphone array includes: a housing provided with microphones inside forming a first and a second microphone part; a first end surface provided with at least two first pickup holes communicated with the microphone of the first microphone part in one-to-one correspondence; and a second end surface provided with at least one second pickup hole communicated with the microphone of the second microphone part in one-to-one correspondence. The first end surface intersects the second end surface, and a preset angle is formed between the extension direction of the first end surface and that of the second end surface. The distance between at least two adjacent microphones is less than half of the wavelength of the response frequency for beamforming. The present disclosure achieves good spatial capture performance with the lowest practical number of microphones.

### TECHNICAL FIELD

The present disclosure relates to the field of communication, and in particular, to a microphone array and a portable device.

### BACKGROUND

With the development of portable devices, multiple microphones are generally arranged near the earphone of the portable device for collecting sound signals in different directions. Thus, the layout of the microphone is particularly important.

Microphone arrays are well known. However, there is relatively few studies on the optimal configuration of new beamforming algorithms. Traditional beamformers, for which there are well-known design rules, require a large number of microphones to achieve good performance (low noise, narrow beams and frequency-independent beam widths). Therefore, more advanced beamforming algorithms were developed. However, the developers of the new algorithm pay little or no attention to the microphone arrays when determining the best microphone configuration used together with the algorithm, so that the actual performance of the algorithm and physical microphone combination may be lower than the best performance.

The object of the present disclosure is to provide a microphone array and a portable device in order to solve technical problems in the prior art, which can provide optimal microphone placement locations for most beamforming algorithms.

In a first aspect, the present disclosure provides a microphone array. The microphone array includes a housing, a first end surface and a second end surface.

The housing includes a plurality of microphones inside. The plurality of microphones includes a first microphone part and a second microphone part. The first microphone part includes at least two microphones inside, and the second microphone portion includes at least one microphones inside.

The first end surface is formed on one surface of the housing and is provided with at least two first pickup holes. The at least two first pickup holes are in one-to-one correspondence communicated with the at least two microphones of the first microphone part.

The second end surface is formed on another surface of the housing and is provided with at least one second pickup hole. The at least one first pickup hole is in one-to-one correspondence communicated with the at least one microphone in the second microphone portion.

As an improvement, the first end surface intersects the second end surface. A preset angle is formed between an extension direction of the first end surface and an extension direction of the second end surface. A distance between at least two adjacent microphones is less than half of a wavelength of a response frequency for beamforming.

According to the microphone array as described above, in an embodiment, along the extension direction of the first end surface, a distance between at least two adjacent microphones of the first microphone part is less than half the wavelength of the response frequency for beamforming; and/or along the extension direction of the second end surface, a distance between at least two adjacent microphones of the second microphone part is less than half of the wavelength of the response frequency for beamforming.

According to the microphone array as described above, in an embodiment, along the extension direction of the second end surface, at least one microphone of the second microphone part deviates from the first end surface; and/or along the extension direction of the first end surface, at least one microphone of the first microphone part deviates from the second end surface.

According to the microphone array as described above, in an embodiment, the housing is provided with a camera module inside, and at least one microphone is integrated into the camera module.

According to the microphone array as described above, in an embodiment, all the microphones in the first microphone part are integrated into the camera module.

According to the microphone array as described above, in an embodiment, at least two microphones of the first microphone part and at least one microphone of the second microphone part are coplanar to form a first imaginary plane, and the other ones of the plurality of microphones are not located in the first imaginary plane.

According to the microphone array as described above, in an embodiment, the first microphone part includes three microphones, and the second microphone part includes two microphones. Two of the microphones of the first microphone part and one of the microphones of the second microphone part are coplanar to form the first imaginary plane, and the other ones of the plurality of microphones are not located in the first imaginary plane and are located at the same side of the first imaginary plane.

According to the microphone array as described above, in an embodiment, at least one microphone is a non-omnidirectional microphone.

According to the microphone array as described above, in an embodiment, the preset angle is 90°.

In a second aspect, the present disclosure provides a portable device including the microphone array as described above.

Compared with the related art, in the present disclosure, multiple microphones are provided in the housing and the multiple microphones are distributed on two adjacent end surfaces, the distance between at least two adjacent microphones is less than half of the response frequency for beamforming, such that a good microphone layout is formed for the beamforming algorithm, enabling good spatial capture performance with the lowest practical number of microphones, and is generally applicable for use with a wide variety of modern and traditional beamforming algorithms.

### BRIEF DESCRIPTION OF DRAWINGS

FIG. 1 is a schematic diagram of microphone array of the first embodiment according to the present disclosure.

FIG. 2 is a schematic diagram of the microphone array of the second embodiment according to the present disclosure.

FIG. 3 is a schematic diagram of the microphone array of the third embodiment according to the present disclosure.

FIG. 4 is a schematic diagram of a beamforming system according to the present disclosure.

Reference signs: 1-housing, 2-first microphone part, 3-second microphone part, 4-microphone, 5-first end surface, 6-first pickup hole, 7-second end surface, 8-second pickup hole, 9-camera module, 10-first imaginary plane.

### DESCRIPTION OF EMBODIMENTS

The embodiments described below by reference to the drawings are exemplary for illustrating the present disclosure, and shall not be interpreted as a limitation to the present disclosure.

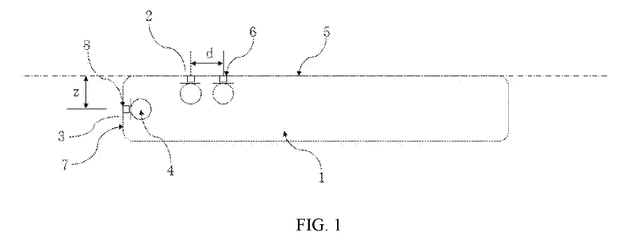

As shown in FIGS. 1 to 4, an embodiment of the present disclosure provides a microphone array including the housing 1, the first end surface 5 is formed on one surface of housing 1, and the second end surface 7 is formed on another surface of housing 1.

A plurality of microphones 4 is provided in the housing for receiving sound waves. The plurality of microphones 4 form a first microphone part 2 and a second microphone part 3. At least two microphones 4 are provided in the first microphone part 2, and at least one microphone 4 is provided in the second microphone part 3. The microphones 4 of the first microphone part 2 are configured to receive sound signals reaching the direction of the first end surface 5, and the microphone 4 in the second microphone part 3 is configured to receive sound signals reaching the direction of the second end surface 7, thereby realizing the acquisition of sound signals in different directions.

In a feasible implementation, the microphones 4 of the first microphone part 2 are installed in the first end surface 5. The first end surface 5 is provided with at least two first pickup holes 6. The number and position of the first pickup holes 6 correspond to the number and position of the microphones 4 of the first microphone part 2. The first pickup holes 6 are communicated with the microphones 4 of the first microphone part 2 in one-to-one correspondence. External sound waves enter the corresponding microphones 4 from the first pickup holes 6, so as to achieve the function of the corresponding microphones 4.

The microphone 4 in the second microphone part 3 is installed in the second end surface 7. The second end surface 7 is provided with at least one second pickup hole 8. The number and location of the second pickup hole 8 corresponds to the number and location of the microphone 4 in the second microphone part 3. The second pickup hole 8 is communicated with the microphone 4 in the second microphone part 3 in one-to-one correspondence. External sound waves enter the corresponding microphone 4 from the second pickup hole 8, so as to achieve the function of the corresponding microphone 4.

The first end surface 5 intersects the second end surface 7. A preset angle is formed between the extension direction of the first end surface 5 and the extension direction of the second end surface 7. As a result, a preset angle is formed between the microphones 4 of the first microphone part 2 and the second microphone part 3. The value of the preset angle can be determined based on the actual situation. In a feasible implementation, the preset angle is 90°. That is, the first end surface 5 and the second end surface 7 intersect each other perpendicularly.

Multiple microphones 4 at different positions in the first microphone part 2 and the second microphone part 3 form a microphone array. There exists differences of the installation position of each microphone 4. Due to the interactions of the slight time differences by the sound signal reaching each microphone 4 in the microphone array, the microphone array can obtain a better directivity than a single microphone 4, and can separate the sound generated by each sound source to filter out the ambient noise, so as to improve the effect of sound pickup and voice identification.

In order to obtain a better de-noising effect, at least two microphones 4 are selected to perform beamforming on the sound signal. The microphones 4 of the first microphone part 2, also the ones in the second microphone part 3, may be selected for beamforming processing, or the microphones 4 in both the first microphone part 2 and the second microphone part 3 may be simultaneously selected for beamforming processing, which is not limited herein. Beamforming processing can be used to focus the microphone array on the sound source, and retain the sound signals in a specific direction and restrain the noise signals in other directions with the directional properties of the sound, thereby increasing the signal-to-noise ratio.

The microphone array for beamforming can be composed of a linear arrangement of microphones 4, or of microphones 4 provided on the same end surface, and can also be composed of microphones 4 provided on different end surfaces to form a stereo microphone array, such that a good arrangement of the microphones 4 can be achieved for beamforming algorithm, enabling good spatial capture performance with the lowest practical number of the microphones 4, and is generally applicable for use with a wide variety of modern and traditional beamforming algorithms.

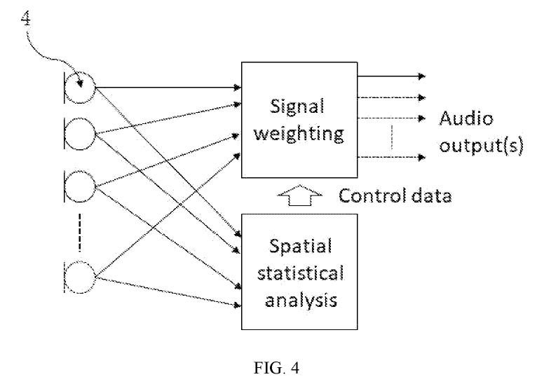

As shown in FIG. 4, the beamforming algorithm can be based on the statistical analysis of the spatial characteristics of the input signal, such as cross-correlation, and can enhance the signal based on the statistical analysis using the parameters derived from the statistical analysis.

In a feasible implementation, as shown in FIG. 1, two microphones 4 are provided in the first microphone part 2, one microphone 4 is provided in the second microphone part 3, and the extension direction of the alignment line between the two microphones 4 of the first microphone part 2 is parallel to the length direction of the housing 1. The microphones 4 of the first microphone part 2 and the second microphone part 3 are combined together to form a strong directional microphone array. In this case, the formed beam can point to the direction of the sound source to strengthen the sound source acquisition effect, and then improve the sound pickup effect.

Further, the distance between at least two adjacent microphones 4 is less than half of the wavelength of the response frequency for beamforming, such that the beamforming generated by the microphones 4 is controlled to be in a range conducive to improving the sound acquisition effect. The response frequency is to be interpreted as the approximate maximum frequency under a certain condition. For example, the response frequency may be 20 kHz for music and general purpose recording, and also, may be about 8 to 12 kHz for wideband speech.

In an embodiment, along the extension direction of the first end surface 5, the distance between at least two adjacent microphones 4 of the first microphone part 2 is less than half of the wavelength of the response frequency for beamforming. This distance is desirable, but it is not strictly required that other microphones 4 of the first microphone part 2 are equally close to this distance limit. For instance, as shown in FIG. 1, the first microphone part 2 is provided with two microphones 4 inside, and the distance d between the two microphones 4 is less than half of the wavelength of the response frequency for beamforming.

Additionally or alternatively, along the extension direction of the second end surface 7, the distance between at least two adjacent microphones 4 in the second microphone part 3 is less than half of the wavelength of the response frequency for beamforming. This distance is desirable, but it is not strictly required that other microphones 4 in the second microphone part 3 are equally close to this distance limit.

In the embodiments of the present disclosure, in order to achieve the processing of separating front and rear, along the extension direction of the second end surface 7, at least one microphone 4 in the second microphone part 3 deviates from the first end surface 5. As shown in FIG. 1, a distance z exists between the microphone 4 in the second microphone part 3 closest to the first end surface 5 and the first end surface 5. The value of the distance z can be determined based on the actual situation, and is not limited herein.

Additionally or alternatively, along the extension direction of the first end surface 5, at least one microphone 4 in the first microphone part 2 deviates from the second end surface 7. A distance z exists between the microphone 4 in the first microphone part 2 closest to the second end surface 7 and the second end surface 7. The value of the distance z can be determined based on the actual situation, and is not limited herein.

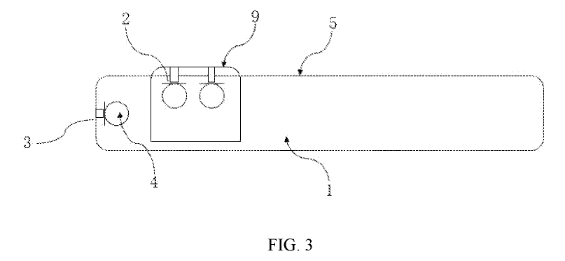

In some embodiments of the present disclosure, according to FIG. 3, the housing 1 is provided with a camera module 9 inside, and at least one microphone 4 is integrated in the camera module 9. In an embodiment, the microphone 4 in the first microphone part 2 are integrated into the camera module 9. In this way, the actual manufacturing will be easier, good sound acoustic design and proper sealing can be ensured, with little or no influence on the beam forming algorithm.

In some embodiments of the present disclosure, at least two microphones 4 of the first microphone part 2 and at least one microphone 4 in the second microphone part 3 are coplanar to form the first imaginary plane 10, and the other microphones 4 are not located in the first imaginary plane 10.

The microphones 4 of the first microphone part 2 in the first imaginary plane 10 are located in the same line, so that the emitting point of the beams are in the same line. Moreover, the microphones 4 of the first microphone part 2 and the microphone 4 of the second microphone part 3 in the first imaginary plane 10 can have two surfaces, respectively, thereby expanding the range of the beam and improving the acquisition effect of the sound source.

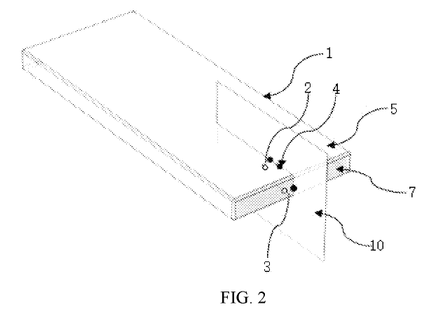

In a feasible implementation, as shown in FIG. 2, the first microphone part 2 is provided three microphones 4 inside, and the second microphone part 3 is provided two microphones 4 inside. The two microphones 4 of the first microphone part 2 and the one microphone 4 of the second microphone part 3 are coplanar to form the first imaginary plane 10. The extension direction of the first imaginary plane 10 is perpendicular to the second end surface 7, and the other microphones 4 are not located in the first imaginary plane 10 and are all located at the same side of the first imaginary plane 10.

In some embodiments of the present disclosure, at least one microphone 4 is a non-omnidirectional microphone 4. The non-omnidirectional microphone 4 refers to a microphone 4 pointing at a single direction, the range of sound signals received by the microphone 4 is a small conical area directly in front of the corresponding pickup hole, and the good directness thereof makes the microphone 4 have a good effect on audio collection in a specific direction, so that the absorption of ambient noise can be effectively reduced.

Based on the microphone array according to the aforementioned embodiments, the present disclosure further provides a portable device. The portable device is a mobile phone, and includes the aforementioned microphone array. A plurality of microphones 4 are provided within the housing 1 of the portable device, and the plurality of microphones 4 are distributed on two adjacent end surfaces. As a result, the distance between at least two adjacent microphones 4 is less than half of the wavelength of the response frequency for beamforming, so that a good layout of the microphones 4 is formed for the beamforming algorithm, enabling good spatial capture performance with the lowest practical number of microphones 4, and is generally applicable to various modern and traditional beamforming algorithms. In this case, the portable device can filter out the ambient noise, and has good effects of sound pickup and voice identification.

The construction, characteristics and effects of the present disclosure are explained in detail according to the aforementioned embodiments shown in the drawings, which are just preferable embodiments of the present disclosure. However, the present disclosure does not limit the scope of implementation as shown in the drawings. All the changes made in accordance with the ideas of the present disclosure, or equivalent embodiments modified into the equivalent changes, which do not go beyond the inspiration covered by the specification and drawings shall fall within the protection scope of the present disclosure.

What is claimed is:

1. A microphone array, comprising:
a housing provided with a plurality of microphones inside, wherein the plurality of microphones form a first microphone part and a second microphone part, the first microphone part comprises at least two microphones, and the second microphone part comprises at least one microphone;
a first end surface formed on one surface of the housing and provided with at least two first pickup holes, wherein the at least two first pickup holes are communicated with the at least two microphones of the first microphone part in one-to-one correspondence;
a second end surface formed on another surface of the housing and provided with at least one second pickup hole, wherein the at least one second pickup hole is communicated with the at least one microphone of the second microphone part in one-to-one correspondence,
wherein the first end surface intersects the second end surface, a preset angle is formed between an extension direction of the first end surface and an extension direction of the second end surface, and a distance between at least two adjacent microphones is less than half of a wavelength of a response frequency for beamforming.

2. The microphone array as described in claim 1, wherein
along the extension direction of the first end surface, a distance between at least two adjacent microphones of the first microphone part is less than half of the wavelength of the response frequency for beamforming; and/or
along the extension direction of the second end surface, a distance between at least two adjacent microphones of the second microphone part is less than half of the wavelength of the response frequency for beamforming.

3. The microphone array as described in claim 1, wherein
along the extension direction of the second end surface, at least one microphone of the second microphone part deviates from the first end surface; and/or
along the extension direction of the first end surface, at least one microphone of the first microphone part deviates from the second end surface.

4. The microphone array as described in claim 1, wherein the housing is provided with a camera module inside, and at least one of the plurality of microphones is integrated into the camera module.

5. The microphone array as described in claim 4, wherein all of the microphones in the first microphone part are integrated into the camera module.

6. The microphone array as described in claim 1, wherein at least two microphones of the first microphone part and at least one microphone of the second microphone part are coplanar to form a first imaginary plane, and the other ones of the plurality of microphones are not located in the first imaginary plane.

7. The microphone array as described in claim 6, wherein the first microphone part comprises three microphones, the second microphone part comprises two microphones, two of the three microphones of the first microphone part and one of the two microphones of the second microphone part are coplanar to form the first imaginary plane, and the other ones of the plurality of microphones are not located in the first imaginary plane and are located at the same side of the first imaginary plane.

8. The microphone array as described in claim 1, wherein at least one microphone is a non-omnidirectional microphone.

9. The microphone array as described in claim 1, the preset angle is 90°.

10. A portable device, comprising the microphone array as described in claim 1.
